(19) United States
(12) Patent Application Publication
(10) Pub. No.: US 2026/0149224 A1
(43) Pub. Date: May 28, 2026

(54) FLOATING CONNECTOR AND CONNECTION SYSTEM

(71) Applicant: Bellwether Electronic Corp., Taoyuan City (TW)

(72) Inventor: Yung-Liang CHI, Taoyuan City (TW)

(21) Appl. No.: 19/336,521

(22) Filed: Sep. 23, 2025

Related U.S. Application Data
(60) Provisional application No. 63/725,553, filed on Nov. 27, 2024.

(51) Int. Cl. H01R 13/631; H01R 12/71

(52) U.S. Cl. CPC H01R 13/6315; H01R 12/716

(57) ABSTRACT

A floating connector includes a base, a housing, and a floating plug. The housing is connected to the base and defines a retaining room with the base. The floating plug is electrically connected to the base and the housing, in which the floating plug has a main body disposed within the housing and a mating portion extending through the housing. The mating portion is configured to receive a force to drive the main body to move limitedly within the retaining room.

### CROSS-REFERENCE TO RELATED APPLICATION

This application claims priority to U.S. Provisional Application Ser. No. 63/725,553, filed Nov. 27, 2024, which is herein incorporated by reference in its entirety.

### BACKGROUND

### Field of Invention

The present invention relates to a connector and a connection system. More particularly, the present invention relates to a floating connector and a connection system using the floating connector.

### Description of Related Art

Conventional connectors with fixed structures have limited adaptability, particularly in the condition of significant assembly tolerances and environmental vibrations. When misalignment occurs due to these tolerances, stress generated by the connector is directly transferred to the solder joints of a mating component, such as a circuit board. This transfer of stress can easily lead to poor electrical contact or permanent damage, thereby creating a significant challenge for applications that demand high reliability, such as those in the automotive and industrial sectors.

Accordingly, the development of a floating connector that can compensate for both tolerances and vibrations has become a critical issue in the industry, so as to combine stability with such compensatory capabilities.

### SUMMARY

The disclosure provides a floating connector includes a base, a housing, and a floating plug. The housing is connected to the base and defines a retaining room with the base. The floating plug is electrically connected to the base and the housing, in which the floating plug has a main body disposed within the housing and a mating portion extending through the housing. The mating portion is configured to receive a force to drive the main body to move limitedly within the retaining room.

In some embodiments of the present disclosure, a width of the main body of the floating plug is smaller than an internal width of the housing.

In some embodiments of the present disclosure, the housing has an annular inner wall surface, and the main body of the floating plug has an annular side wall.

In some embodiments of the present disclosure, the mating portion passes through an opening of the housing, and a width of the mating portion is smaller than a width of the opening.

In some embodiments of the present disclosure, a distance between an inner top surface of the housing and a top surface of the base is greater than or equal to a height of the main body of the floating plug.

In some embodiments of the present disclosure, the floating connector further includes a first elastic member and/or a second elastic member. The first elastic member abuts between the main body of the floating plug and the housing, and the second elastic member abuts between the base and the main body of the floating plug.

In some embodiments of the present disclosure, the main body of the floating plug has a first annular groove adjacent to the housing, and the first elastic member is annular and is disposed in the first annular groove.

In some embodiments of the present disclosure, the housing has a first annular groove adjacent to the main body of the floating plug, and the first elastic member is annular and is disposed in the first annular groove.

In some embodiments of the present disclosure, the main body of the floating plug has a second annular groove adjacent to the base, and the second elastic member is annular and is disposed in the second annular groove.

In some embodiments of the present disclosure, the base further has a second annular groove adjacent to the main body of the floating plug, and the second elastic member is annular and is disposed in the second annular groove.

In some embodiments of the present disclosure, the first elastic member and the second elastic member are coaxially arranged.

Another aspect of the present disclosure is related to a connection system which includes a carrier board, at least one floating connector and a connector. The floating connector is mounted on the carrier board and includes a base, a housing, and a floating plug. The housing is connected to the base and defines a retaining room with the base. The floating plug is electrically connected to the base and the housing, in which the floating plug has a main body disposed within the housing and a mating portion extending through the housing. The mating portion is configured to receive a force to drive the main body to move limitedly within the retaining room. The connector includes at least one slot configured to receive the mating portion of the floating connector.

In some embodiments of the present disclosure, the at least one floating connector includes two floating connectors, and the connector comprises two slots configured to respectively receive the mating portions of the two floating connector.

In some embodiments of the present disclosure, the at least one slot of the connector includes a crown spring disposed in the slot.

In summary, the floating connector of the present disclosure has an excellent capability for lateral tolerance compensation. Elastic members within the floating connector are beneficial for the limited displacement of the floating plug to engage a mating component. Furthermore, the floating plug can be further displaced in a vertical direction, thereby providing three-dimensional tolerance compensation and vibration absorption functions. This significantly enhances the reliability of the electrical and mechanical connection.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a floating connector, according to some embodiments of the present disclosure;

FIG. 2 is an exploded view of the floating connector, according to some embodiments of the present disclosure;

FIG. 3 is a cross-sectional view of the floating connector, taken along the section line C of FIG. 1;

FIG. 4 is a cross-sectional view of a floating connector, according to other embodiments of the present disclosure;

FIG. 5 is a cross-sectional view of a floating connector, according to other embodiments of the present disclosure;

FIG. 6 is a cross-sectional view of a floating connector, according to other embodiments of the present disclosure;

FIG. 7 is a schematic view of the floating connector and a cable-end connector, according to some embodiments of the present disclosure; and

FIG. 8 is a schematic view of the floating connector, the cable-end connector, and a carrier board, according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be restricting. In addition, for ease of description, a first axial direction X, a second axial direction Y, and a third axial direction Z are defined herein. The first axial direction X, the second axial direction Y, and the third axial direction Z are mutually perpendicular and serve as a reference for describing the relative positions, arrangements, and force directions of the components.

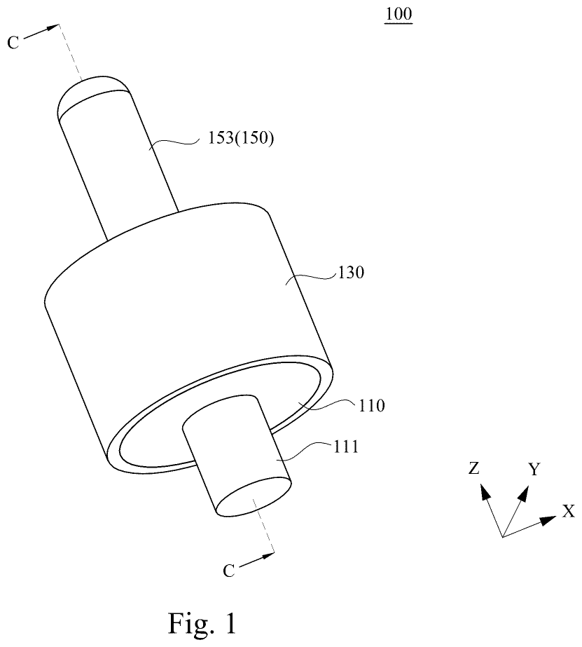

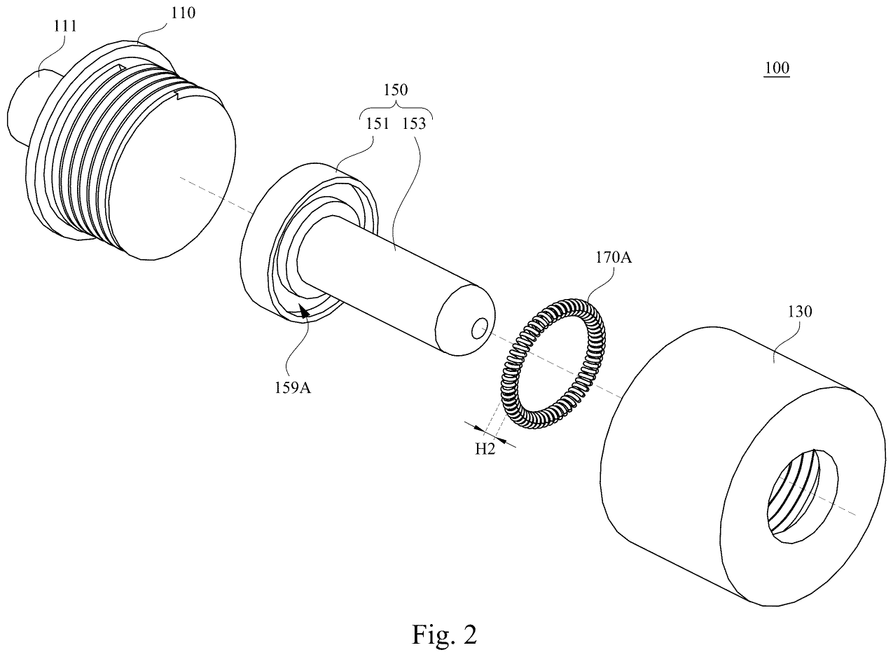

Referring to FIG. 1 and FIG. 2, a floating connector 100 is provided in some embodiments of the present disclosure. The floating connector 100 can be used in board-to-wire and board-to-board connection scenarios, and the floating connector 100 is particularly suitable for applications that involve vibration or require compensation for assembly tolerances, such as in automotive electronics, industrial equipment, or automated machinery.

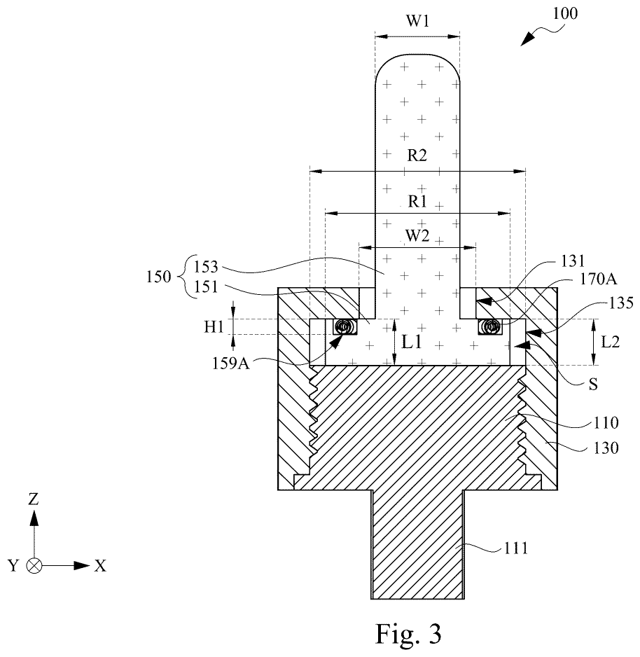

Referring to FIG. 2 and FIG. 3, the floating connector 100 includes a base 110, a housing 130, and a floating plug 150. Specifically, the base 110 is configured to connect to a circuit board or other electronic components. The base 110 is made of a conductive material, such as copper or a copper alloy. A bottom of the base 110 includes a connecting portion 111 that extends along the third axial direction Z. The connecting portion 111 is used for establishing stable mechanical and electrical connection with a circuit board or other electronic components. The connecting portion 111 may be cylindrical, square, or other polygonal columns, and the disclosure is not limited in this respect.

The housing 130 is connected to the top of the base 110. The housing 130 and the base 110 may be joined by threaded engagement, snap-fitting, welding, or other methods. The housing 130 is also made of a conductive material, such as copper or a copper alloy, and the housing 130 defines a retaining room S. The retaining room S is configured to accommodate the floating plug 150 and defines a motion range for the floating plug 150.

The floating plug 150 is the core component for fulfilling the floating function. The floating plug 150 is electrically connected to the base 110 and the housing 130, and the floating plug 150 is at least partially accommodated within the retaining room S. The floating plug 150 is made of a conductive material, such as copper or a copper alloy. The floating plug 150 has a main body 151 located within the retaining room S and a mating portion 153 extending upward from an upper surface of the main body 151 through the housing 130. The mating portion 153 passes through an opening 131 of the housing 130 to connect to an external connector or other electronic components.

Specifically, the main body 151 is a cylinder and has an annular side wall, while the housing 130 has an annular inner wall surface 135 which extends around the third axial direction Z to define the retaining room S. Furthermore, a width R1 of the main body 151 is smaller than an internal width R2 of the housing 130, thereby forming a gap between the main body 151 and the housing 130 for the main body 151 for the motion of the main body 151. In addition, the mating portion 153 is a column (e.g., a cylinder, a square column, or other polygonal column), and the opening 131 has a shape corresponding to the mating portion 153 (e.g., circular, square, or other polygon). Specifically, a width W1 of the mating portion 153 is smaller than a width W2 of the opening 131. Therefore, when an external component cannot be accurately aligned with the mating portion 153, an external force applied to the mating portion 153 will drive the main body 151 to move within the retaining room S. The width R1 of the main body 151 is greater than the width W2 of the opening 131, which prevents the floating plug 150 from detaching from the housing 130. This allows the floating connector 100 to actively compensate for positional offsets from multiple directions and prevents stress from external components from being directly transferred to the base 110 and the electronic components connected the base 110, thereby significantly enhancing product reliability and durability. Specifically, a difference between the width W1 of the mating portion 153 and the width W2 of the opening 131 is the same as the a difference between the width R1 of the main body 151 and the internal width R2 of the housing 130, which allows the floating plug 150 to move more effectively within the retaining room S for maintaining excellent conductivity instead of wasting conductive material.

In some embodiments, the floating connector 100 further includes a first elastic member 170A. The first elastic member 170A is an annular elastic element (e.g., an annular spring or an elastic piece spirally wound around the mating portion 153) and is made of an elastic conductive material (e.g., copper, copper alloy, Phosphor Bronze, Beryllium Copper (CuBe), or Tin Bronze (CuSn)). The first elastic member 170A abuts between the main body 151 of the floating plug 150 and the housing 130. As the floating plug 150 moves, the first elastic member 170A can continuously apply pressure to the floating plug 150, which is beneficial for maintaining electrical stability and reducing contact resistance between the floating plug 150 and the base 110.

Please refer to FIG. 2 and FIG. 3. In some embodiments of the present disclosure, the floating plug 150 includes a first annular groove 159A located on the top of the main body 151. The first annular groove 159A is adjacent to the inner top surface of the housing 130 to accommodate and position the first elastic member 170A. A height H1 of the first annular groove 159A is slightly smaller than an initial height H2 of the first elastic member 170A (i.e., the height H2 of the first elastic member 170A in FIG. 2 when not subjected to external force). Thus, after the first elastic member 170A is placed in the first annular groove 159A and compressed by the housing 130, the first elastic member 170A elastically deforms and continuously applies pressure to the floating plug 150, thereby ensuring a good conductive connection and lower contact resistance between the floating plug 150 and the base 110. In some embodiments, the base 110 may include a cylindrical main body with a threaded side wall, and the housing 130 has a corresponding threaded inner wall surface that surrounds the base 110. By rotating the base 110, a distance L2 between the inner top surface of the housing 130 and the top surface of the base 110 can be adjusted to be slightly greater than or equal to a height L1 of the main body 151. When the distance L2 is equal to the height L1 of the main body 151, the floating plug 150 only moves in a planar direction defined by the first axial direction X and the second axial direction Y. When the distance L2 is greater than the height L1 of the main body 151, the floating plug 150 can move not only in the planar direction but also have limited displacement along the third axial direction Z.

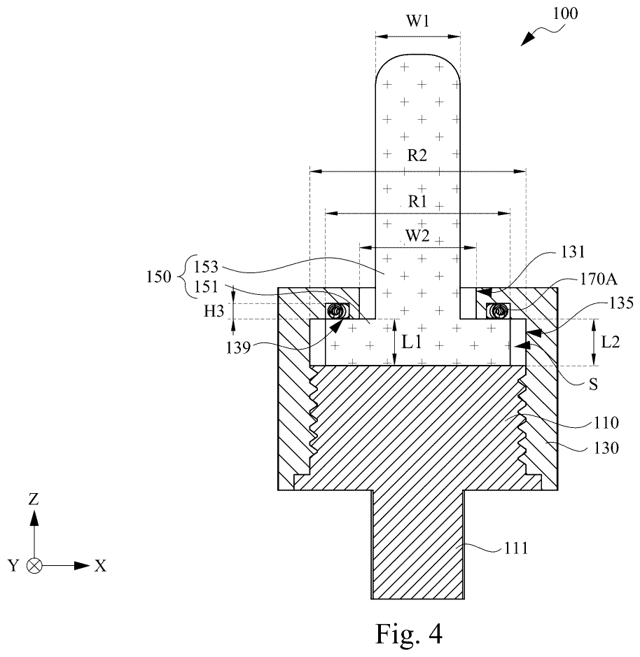

Referring to FIG. 4, a cross-sectional view of a floating connector 100 according to other embodiments of the present disclosure is shown. In this embodiment, the housing 130 further includes a first annular groove 139 located on the inner top of the housing 130 and adjacent to the main body 151 of the floating plug 150, for accommodating the first elastic member 170A. Similarly, when a height H3 of the first annular groove 139 is slightly smaller than the initial height H2 of the first elastic member 170A, the first elastic member 170A, upon being installed into the first annular groove 139, is compressed by the housing 130, thereby elastically deforming and continuously applying pressure to the floating plug 150 to ensure electrical stability and reduce contact resistance.

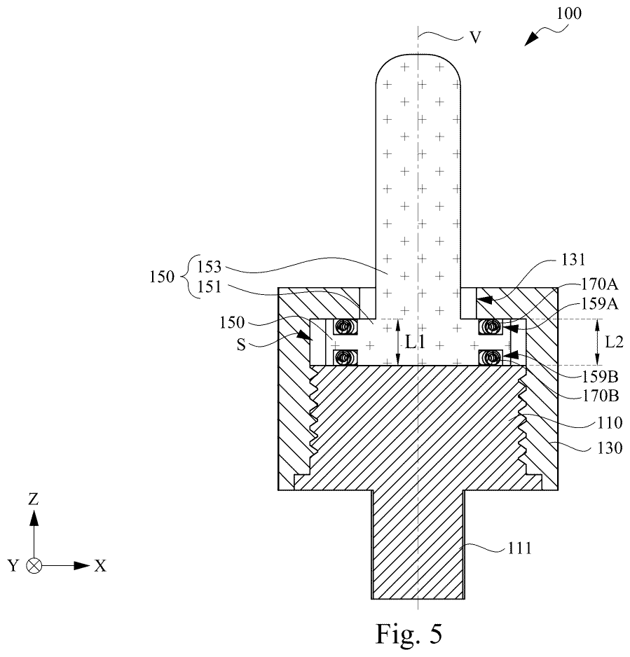

Referring to FIG. 5, a cross-sectional view of a floating connector 100 according to other embodiments of the present disclosure is shown. To further enhance the floating and buffering capabilities in the third axial direction Z, the floating connector 100 may include a second elastic member 170B, which is made of a material similar to the material of the first elastic member 170A. The first elastic member 170A abuts between the top of the main body 151 and the inner top surface of the housing 130, while the second elastic member 170B abuts between the bottom of the main body 151 and the top surface of the base 110. When the distance L2 between the inner top surface of the housing 130 and the top of the base 110 is greater than the height L1 of the main body 151, the top-and-bottom arrangement of the first elastic member 170A and the second elastic member 170B not only facilitates the movement of the floating plug 150 along the third axial direction Z, but the inclusion of the second elastic member 170B also offers buffering and protection for the floating connector 100. Specifically, a second annular groove 159B may be disposed at the bottom of the floating plug 150 to accommodate the second elastic member 170B, and the second annular groove 159B is adjacent to the top of the base 110. The first annular groove 159A and the second annular groove 159B can have the same dimensions and be aligned, such that the first annular groove 159A and the second annular groove 159B are coaxially arranged and surround the same axis V, which passes through a center of the first annular groove 159A and a center of the second annular groove 159B. The annular first elastic member 170A and the annular second elastic member 170B, which surround the same axis V, also have the same dimensions and are coaxially arranged, thereby ensuring that the floating plug 150 receives uniform supporting spring force to improve the buffering and restoring functions of the floating connector 100. In other embodiments, the first annular groove 159A and the second annular groove 159B may have different dimensions, and the first elastic member 170A and the second elastic member 170B would then have correspondingly annular shapes with different inner diameters. In one specific embodiment, the inner diameter of the first annular groove 159A is greater than the inner diameter of the second annular groove 159B, and the inner diameter of the first elastic member 170A is greater than the inner diameter of the second elastic member 170B, though the disclosure is not limited thereto.

In other embodiments, the first elastic member 170A and the second elastic member 170B may have the same dimensions but be made of different elastic materials, and the elastic modulus of the first elastic member 170A is greater than that of the second elastic member 170B. Therefore, when the first elastic member 170A and the second elastic member 170B have the same amount of deformation, the first elastic member 170A generates a greater pressure than the second elastic member 170B, though the disclosure is not limited thereto.

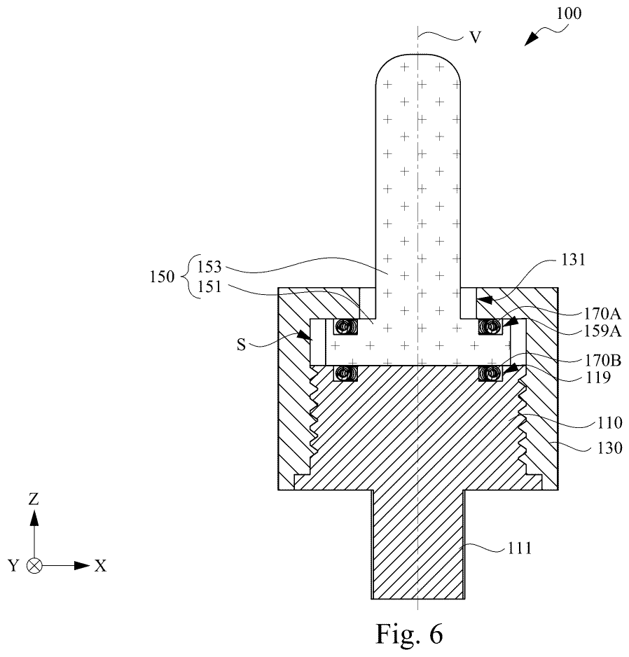

Referring to FIG. 6, a cross-sectional view of a floating connector 100 according to other embodiments of the present disclosure is shown. The base 110 includes a second annular groove 119 for accommodating the second elastic member 170B. The second annular groove 119 is located on the top of the base 110 and is adjacent to the bottom of the main body 151 of the floating plug 150. In this embodiment, by disposing the first annular groove 159A and the second annular groove 119 on the floating plug 150 and the base 110 respectively, removal of excessive conductive material from the floating plug 150 can be avoided, thereby preventing negative impacts on the conductivity of the floating plug 150 and maintaining overall structural stability. The first annular groove 159A and the second annular groove 119, which are coaxially arranged, may have the same dimensions and surround the same axis V, which passes through a center of the first annular groove 159A and a center of the second annular groove 119. Variations in size, material, and other related aspects of the first elastic member 170A and the second elastic member 170B have been described in the preceding paragraphs and will not be repeated here.

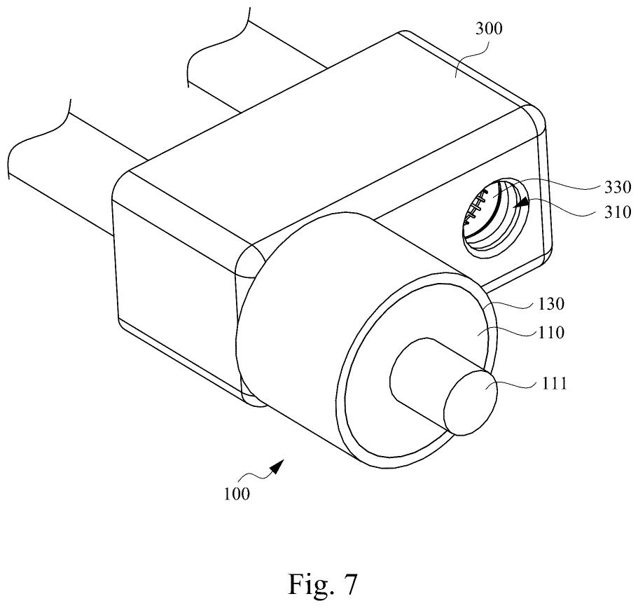

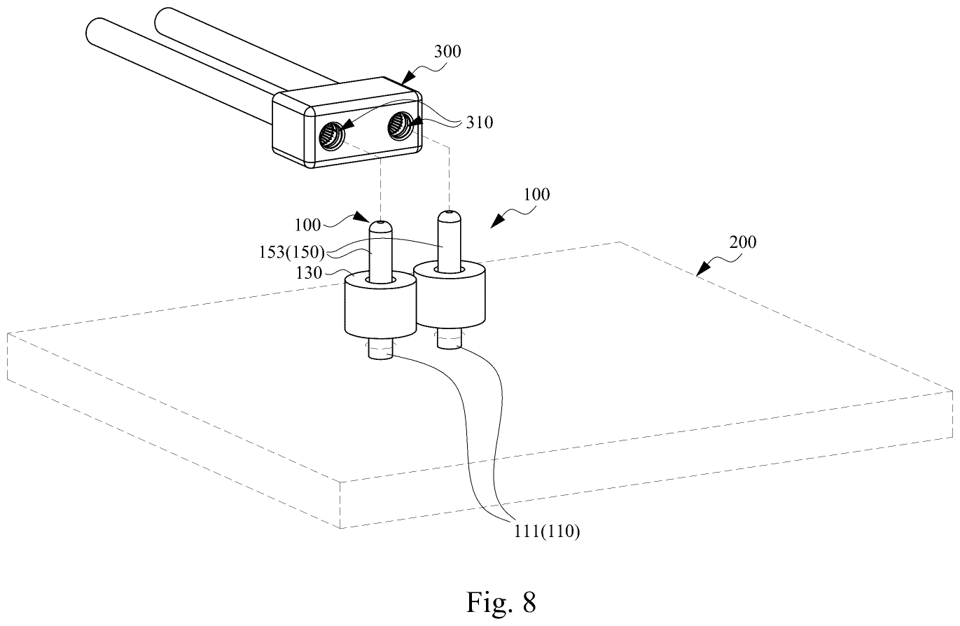

Referring to FIG. 7 and FIG. 8, perspective views of a connection system according to some embodiments of the present disclosure are shown. The connection system includes two adjacent floating connectors 100 and a carrier board 200, while both floating connectors 100 are mounted on the carrier board 200 (e.g., a circuit board). A user can hold a cable-end connector 300 having dual slots 310, allowing the dual slots 310 respectively receive the mating portions 153 of the two floating connectors 100. The relative positions of the two bases 110 on the carrier board 200 are fixed, so the spacing between the dual slots 310 is also fixed. However, the two floating plugs 150 are configured to move independently of each other, and this allows the two mating portions 153 to move limitedly and align for insertion into the dual slots 310. This compensates for spacing tolerance of the dual slots 310, thereby providing a smooth and reliable mating process. Additionally, the cable-end connector 300 may include crown springs 330 disposed within the slots 310. When the floating connector 100 mates with the cable-end connector 300, the crown springs 330 are elastically deformed by the pressure from the mating portions 153, thereby establishing a stable electrical connection between the mating portions 153 and the slots 310.

In summary, the floating connector of the present disclosure provides a fundamental radial floating function through the gap between the floating plug and the housing. By adding elastic members, an automatic restoring function can be further strengthened. Moreover, through its sophisticated structural design, the floating connector of the present disclosure can provide comprehensive, three-dimensional compensation capabilities to address more complex assembly tolerances, demonstrating extremely high product reliability.

What is claimed is:

1. A floating connector, comprising:
a base;
a housing connected to the base and defining a retaining room with the base; and
a floating plug electrically connected to the base and the housing, wherein the floating plug has a main body disposed within the housing and a mating portion extending through the housing, wherein the mating portion is configured to receive a force to drive the main body to move limitedly within the retaining room.

2. The floating connector of claim 1, wherein a width of the main body of the floating plug is smaller than an internal width of the housing.

3. The floating connector of claim 1, wherein the housing has an annular inner wall surface, and the main body of the floating plug has an annular side wall.

4. The floating connector of claim 1, wherein the mating portion passes through an opening of the housing, and a width of the mating portion is smaller than a width of the opening.

5. The floating connector of claim 1, wherein a distance between an inner top surface of the housing and a top surface of the base is greater than or equal to a height of the main body.

6. The floating connector of claim 1, further comprising a first elastic member, wherein the first elastic member is disposed between and abuts against the main body of the floating plug and the housing.

7. The floating connector of claim 1, further comprising a first elastic member, wherein the main body of the floating plug has a first annular groove adjacent to the housing, and wherein the first elastic member is annular and disposed in the first annular groove.

8. The floating connector of claim 1, further comprising a first elastic member, wherein the housing has a first annular groove adjacent to the main body of the floating plug, and wherein the first elastic member is annular and disposed in the first annular groove.

9. The floating connector of claim 1, further comprising:
a second elastic member disposed between and abutting against the base and the main body of the floating plug.

10. The floating connector of claim 1, further comprising:
a second elastic member disposed between the base and the main body of the floating plug, wherein the main body of the floating plug has a second annular groove adjacent to the base, and wherein the second elastic member is annular and disposed in the second annular groove.

11. The floating connector of claim 1, further comprising:
a second elastic member disposed between the base and the main body of the floating plug, wherein the base has a second annular groove adjacent to the main body of the floating plug, and wherein the second elastic member is annular and disposed in the second annular groove.

12. The floating connector of claim 6, further comprising:
a second elastic member disposed between and abutting against the base and the main body of the floating plug, wherein the first elastic member and the second elastic member are coaxially arranged.

13. The floating connector of claim 7, further comprising:
a second elastic member disposed between the base and the main body of the floating plug, wherein the main body of the floating plug has a second annular groove adjacent to the base, and wherein the second elastic member is annular and disposed in the second annular groove, wherein the first elastic member and the second elastic member are coaxially arranged.

14. The floating connector of claim 8, further comprising:
a second elastic member disposed between the base and the main body of the floating plug, wherein the base has a second annular groove adjacent to the main body of the floating plug, and wherein the second elastic member is annular and disposed in the second annular groove.

15. A connection system, comprising:
a carrier board;
at least one floating connector mounted on the carrier board, the floating connector comprising:
a base;
a housing connected to the base and defining a retaining room with the base; and
a floating plug electrically connected to the base and the housing, wherein the floating plug has a main body disposed within the housing and a mating portion extending through the housing, and wherein the mating portion is configured to receive a force to drive the main body to move limitedly within the retaining room; and
a connector comprising at least one slot configured to receive the mating portion of the floating connector.

16. The connection system of claim 15, wherein the at least one floating connector comprises two floating connectors, and the connector comprises two slots configured to respectively receive the mating portions of the two floating connector.

17. The connection system of claim 15, wherein the at least one slot of the connector comprises a crown spring disposed in the slot.
